(19) United States
(12) Patent Application Publication
(10) Pub. No.: US 2011/0007933 A1
(43) Pub. Date: Jan. 13, 2011

(54) 3D Image Processing

(75) Inventor: Victor Lempitsky, Cambridge (GB)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/501,145

(22) Filed: Jul. 10, 2009

(51) Int. Cl. G06K 9/00; G06T 17/00; G06K 9/40

(52) U.S. Cl. 382/100; 345/424; 382/275

(57) ABSTRACT

Three dimensional image processing is described for example, for digital rendering of real-world objects, medical imaging applications and digital effects rendering. In an example, a 3D image processing apparatus takes a binary volume representation of a three dimensional image and forms an embedding function substantially consistent with the binary volume. In examples, the embedding function is smoothed by regularizing the at least second order derivatives and optimized using a convex optimization engine. In an embodiment the optimized embedding function is used to create a surface representation of the three dimensional object using an iso-surface extraction engine. In another embodiment the surface representation may be directly rendered on a display using volume rendering techniques.

### BACKGROUND

Three dimensional image processing is used in many application domains such as medical imaging, digital effects, virtual reconstruction and multiview reconstruction. For example, segmentation algorithms such as region growing, graph cuts or thresholding can be used to label image elements in a 3D image as belonging to either the foreground or the background. This is useful in application domains where it is required to separate an object of interest from a background in order to perform further measurements or processing. The output of these methods is a three dimensional image segmentation mask where all image elements comprising part of the foreground image are labeled with one value and all image elements comprising part of the background image are labeled with another value, this is known as a binary volume.

The 3D image segmentation result can be represented in the form of a separating surface; that is, a surface which separates the background and the foreground section of a binary volume. In many applications this surface representation can correspond to an actual physical interface. For example, in biomedical imaging, this surface may correspond to the boundary of an organ.

The problem of surface extraction from these binary volumes is needed for many applications. A surface representation can be extracted as corresponding to an isosurface at the median value of the binary volume using iso-surface extraction engines. For example, if the background label is interpreted as −1 and the foreground label is interpreted as 1, the median value is 0 and this is described as a zero-isosurface. These isosurfaces contain aliasing artifacts such as “jagginess” and “terracing” which can have a regular structure, caused by the fact that that the binary volume does not define a unique surface representation but can be consistent with an entire family of surfaces. When these isosurfaces are rendered on a display the Bagginess and other artifacts make them difficult to interpret and use for ongoing purposes, such as medical diagnosis, object recognition, computer aided design and manufacture and other applications.

One approach to minimize these artifacts is local Gaussian pre-filtering of the binary volume. This approach often requires a very large kernel and strong filtration to diminish the artifacts and such filtration smoothes out fine details and produces surfaces which can be incompatible with the original binary volumes. This is unsatisfactory for many practical applications such as medical diagnosis and manufacturing where it is required to obtain a 3D surface representation which depicts a 3D object in the scene being imaged with high fidelity.

Another approach evolves the extracted surface representation to minimize its area, subject to the constraint that it remains consistent with the original binary volume during the evolution. One method of minimizing the area of the surface representation is to modify the underlying three-dimensional mask such that the area of its zero-isosurface is minimized. This leads to surface representations that are significantly smoother than the original median isosurface but still suffer from visible artifacts and in addition the minimal area objective leads to artifacts on thin protrusions and sharp creases of the object.

In addition, this presents a difficult computational problem as the modification of the underlying three-dimensional mask is a non-convex problem, which can be computationally unstable and will not converge to the minimum representation without small step sizes, which increases the time needed to extract the surface. Thus previously, computational resources required and time needed to produce good quality, smooth, 3D surface representations has been great.

There is a need to provide a method of 3D image processing that improves the depiction of the surface representation by eliminating artifacts and increasing accuracy while reducing the computational resources and time required.

The embodiments described below are not limited to implementations which solve any or all of the disadvantages of known three dimensional image processing systems.

### SUMMARY

Three dimensional image processing is described for example, for digital rendering of real-world objects, medical imaging applications and digital effects rendering. In an example, a 3D image processing apparatus takes a binary volume representation of a three dimensional image and forms an embedding function substantially consistent with the binary volume. In examples, the embedding function is smoothed by regularizing the at least second order derivatives and optimized using a convex optimization engine. In an embodiment the optimized embedding function is used to create a surface representation of the three dimensional object using an iso-surface extraction engine. In another embodiment the surface representation may be directly rendered on a display using volume rendering techniques.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a three dimensional image processing system;

FIG. 2 is a flow diagram of a method carried out at a 3D image processing system to obtain a surface representation;

FIG. 3 shows examples in two dimensions of surfaces with aliasing artifacts;

FIG. 4 is a flow diagram describing a method of smoothing a surface representation by optimizing an embedding function;

FIG. 5 is a flow diagram illustrating a smoothing engine in more detail;

FIG. 6 is an example in two dimensions of an optimized embedding function;

FIG. 7 is a flow diagram of a method used to reconstruct fine scale structures at the 3D image processing system;

FIG. 8 is an example method of reconstructing fine scale structures in more detail;

FIG. 9 illustrates an exemplary computing-based device in which embodiments of a 3D image processing system may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a 3D image processing system which carries out surface extraction, the system described is provided as an example and not a limitation. As those skilled in the art will appreciate, the present examples are suitable for application in a variety of different types of 3D image processing systems.

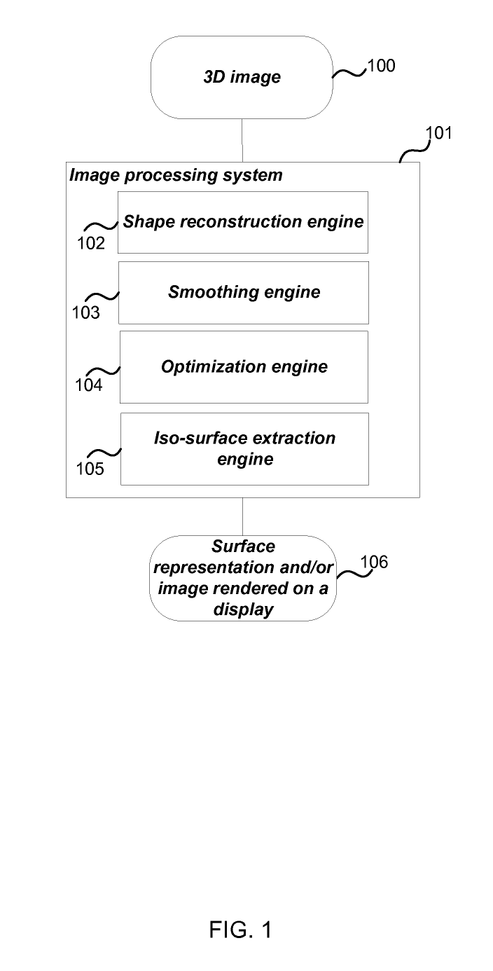

FIG. 1 is a schematic diagram of a three dimensional image processing apparatus implemented using a computer or processor of any suitable type. The 3D image processing apparatus comprises an input 100, a 3D image processing system 101 and an output 106. The components of the 3D image processing system 101 comprise a shape reconstruction engine 102, a smoothing engine 103, an optimization engine 104 and an iso-surface extraction engine 105. The output of the three dimensional image processing system is in the form of a surface representation or image rendered on a display 106.

The input 100 can be an input from a camera, video camera, data store or any other appropriate source of 3D image data in communication with the 3D image processing system 101. 3D image data is used herein in a broad sense to describe any form of 3D image or higher dimensional images such as CT scans, MRI scans or other digital medical images, images obtained from Z-cameras, voxel volumes, satellite imaging systems, ultrasound scans, sequences of data such as videos or other captured or generated sequences of images or any other appropriate 3D or higher dimensional image data.

The shape reconstruction engine 102 can be any form of engine implemented at a processor designed to perform binary image segmentation by labeling image elements as belong to either foreground or background, such as region growing, graph cuts or thresholding or any other appropriate image segmentation algorithm, and from the image labeling form a binary volume.

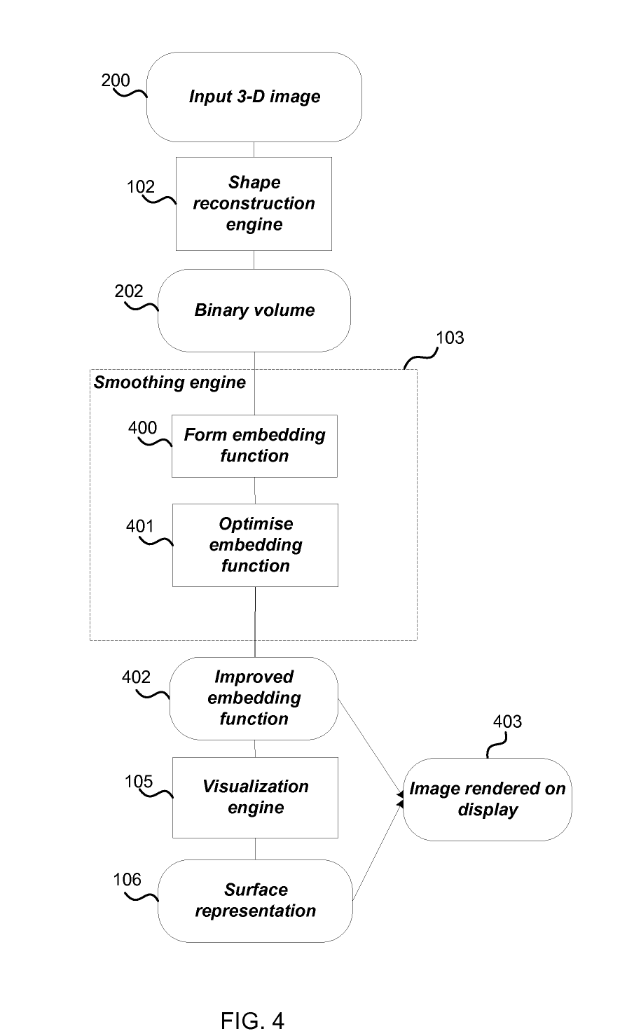

The smoothing engine 103 is arranged to form an embedding function from the binary volume which can then be optimized by the optimization engine 104 to obtain an improved embedding function. A binary volume can be thought of as an example of an embedding function and the smoothing engine 103 is arranged to transform the binary values of the binary volume to non-binary values to give a smoother surface representing the 3D objects depicted in the image. The formation of an embedding function is described in more detail with reference to FIG. 4 herein. The improved embedding function can then be used by the iso-surface extraction engine 105 to extract a surface representation 106. The surface representation can then be displayed on an output 106, which may be in the form of a display. The term “embedding function” is used herein to refer to a representation of a 3D surface of one or more objects depicted in a 3D or higher dimensional image. For example, an embedding function may be a plurality of numbers stored in an array or any other data structure. One number is provided for each voxel or other image element and the number indicates whether the centre (for example) of that voxel or other image element is inside or outside the depicted objects. In some examples, the embedding function is a binary volume when the values can take one of only two possible values labeling the image elements as being either inside or outside the objects. In other examples, the embedding function comprises continuous valued numbers.

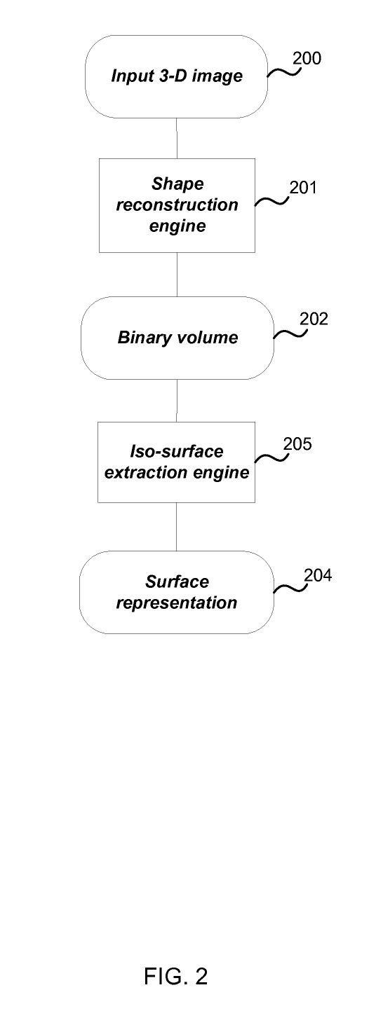

FIG. 2 is a flow diagram of a method carried out at a 3D image processing system to obtain a surface representation. Image data 200 is input into a shape reconstruction engine 201 to obtain a binary volume 202. The binary volume can then be input into an iso-surface extraction engine 205 to obtain a surface representation 204. The term “iso-surface” is used to refer to a 2D manifold defined by an embedding function which represents the surface of one or more objects depicted in a 3D or higher dimensional image.

The image data 200 is input in the form of a medical image, range scan, depth map or any other appropriate 3D or higher dimensional image is input into the shape reconstruction engine 201. The shape reconstruction engine 201 may be a method of binary image segmentation such as region growing or another appropriate method. The output of the shape reconstruction engine 201 is a binary volume 202. The binary volume separates the foreground image components from the background image components by labeling each image element. An image element may be a voxel or a group of voxels. For example the foreground elements can be labeled as valued 1 and the background components can be labeled as −1.

The binary volume can be specified by a function such that the binary function V is given by V:G→{−1,+1} where G is the discrete grid domain G={1,2, . . . , L}×{1,2, . . . , M}×{1,2, . . . , N}. The value of v on the respective node on the grid is Vᵢⱼₖ∈{−1,+1}.

The binary volume 202 can be used by the iso-surface extraction engine 203 implemented at a processor. The iso-surface extraction engine 203 can implement an algorithm such as “marching cubes”. The marching cubes algorithm proceeds through voxels of the 3D image 200, taking eight neighboring locations at a time (thus forming an imaginary cube), then determining the isosurface that passes through this cube. The individual parts of the isosurface determined for each cube are then pieced together to form the desired surface representation 204.

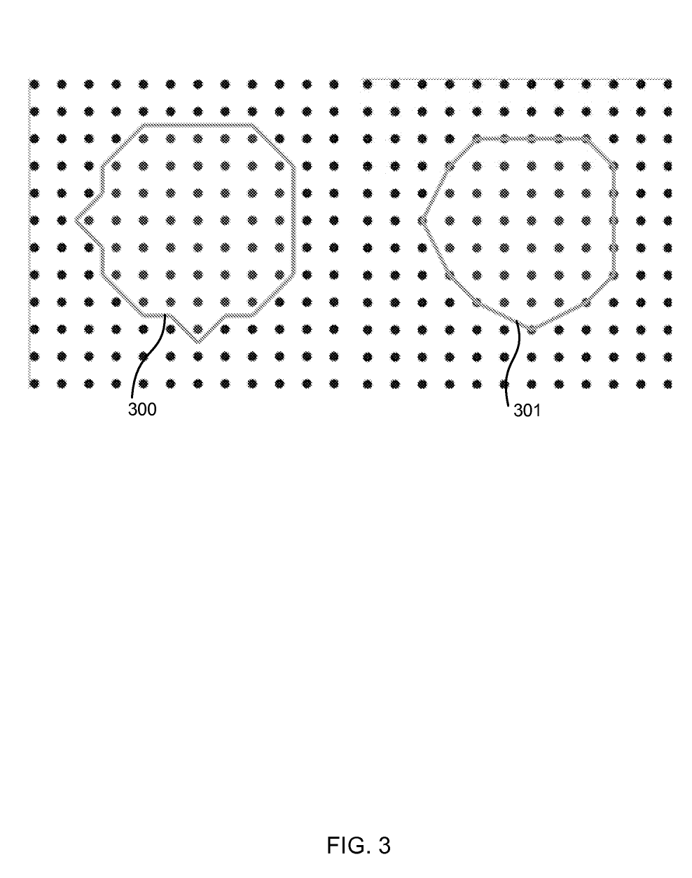

FIG. 3 shows a possible example in two dimensions of the output 300 from the image processing method described in FIG. 2. The input binary volume is obtained by sampling a circle on a coarse (8×8) grid. The zero isosurface 300 output from the marching cubes algorithm 203 lacks smoothness and contains aliasing artifacts. If the zero isosurface 300 output were to be a true representation of the input it would depict a circle of a diameter corresponding to the input.

In another example, a further step is applied to evolve the embedding function of the extracted surface to minimize its area. This method is biased toward obtaining constant embedding functions, which while the surface still contains artifacts also biases the surface representation toward a smaller surface representation than is present in reality. For example, FIG. 3 shows a 2D illustration of a zero isosurface 301 output from such a process applied to the same 3D image of a sphere as used to produce isosurface 300. This output is smooth compared with the marching cubes output 300 but it has a diameter smaller than the sphere depicted in the 3D input image.

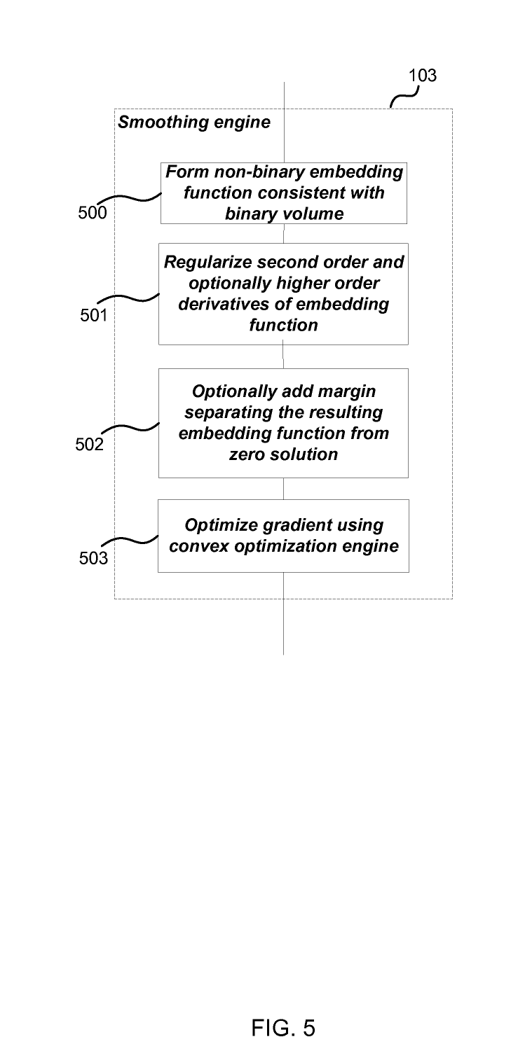

A method of 3D image processing involving the extraction of smooth surface representations based on the constrained convex optimization of the second or higher order derivatives of the embedding function to impose smoothness is now discussed with regards to FIG. 4 and FIG. 5. In these examples the input binary volume is one example of an embedding function input to the 3D image processing system. It is also possible to use a continuous-valued embedding function as input where it is required to improve the smoothness and fidelity of that embedding function.

FIG. 4 is a flow diagram describing a method of smoothing a binary volume surface representation by optimizing an embedding function. As described in FIG. 2 the input comprises a 3D image 200, from which a shape reconstruction engine 102 creates a binary volume 202. The binary volume is then input to a smoothing engine 103 which first forms 400 and then optimizes 401 an embedding function. The optimized embedding function 402 is then input to an iso-surface extraction engine 105 which can either use an algorithm such as “marching cubes” to construct a surface representation 106 (such as an isosurface), or alternatively directly render the image to a display 403. It is recognized herein that, by optimizing 401 an embedding function such that smoothness is imposed on the embedding function directly, the obtained isosurface also possesses a degree of smoothness.

FIG. 5 is a flow diagram describing the smoothing engine 103 in more detail. The smoothing engine is arranged to form and store using a suitable data structure, an embedding function 400 such that it is a non-binary embedding function 500 consistent with the binary volume. The smoothing engine is arranged to carry out optimization 401 of the embedding function comprising: regularizing the second order and, optionally, higher order 501 derivatives of the embedding function; adding a margin 502 separating the resulting embedding function from a zero solution and optimizing the gradient 503 using a non-convex optimization engine.

The non-binary embedding function F 400, 500 is obtained such that F:G→R, where fᵢⱼₖ∈ R denotes the value of F on the node of the grid. The obtained function F is substantially consistent with the binary volume V, so that the zero-isosurface extracted from (the continuous interpolation of) F contains all foreground nodes {i,j,k|vᵢⱼₖ=+1}inside (or on the boundary) and all background nodes {i,j,k|vᵢⱼₖ=−1}outside (or on the boundary). This requirement is equivalent to the following set of hard constraints imposed on F:

∀i,j,k vᵢⱼₖ·f_{ijk≧}0. (1)

to obtain F constraints (1) are met so that zero isosurface is smooth.

The smoothing engine 103 is arranged such that smoothness is imposed on the embedding function directly in order to optimize 401 the formed embedding function. The smoothness is imposed by regularizing the at least second order derivatives of the embedding function such that in the continuous limit, the following functional is minimized:

$$\int {( \frac{{\partial }^{2} F}{\partial {x}^{2}} )}^{2} + {( \frac{{\partial }^{2} F}{\partial {y}^{2}} )}^{2} + {( \frac{{\partial }^{2} F}{\partial {z}^{2}} )}^{2} d V \to min . \qquad ( 2 )$$

In the discrete setting, the finite-difference approximation is used:

Σᵢⱼₖ[(fᵢ₊₁ⱼₖ+fᵢ₋₁ⱼₖ−2fᵢⱼₖ)²+(fᵢⱼ₊₁ₖ+fᵢⱼ₋₁ₖ−2fᵢⱼₖ)²+(fᵢⱼₖ₊₁+fᵢⱼₖ₋₁−2fᵢⱼₖ)²→min. (3)

Regularizing 501 the embedding function and combining it with the hard constraints may lead to the trivial solution F≡0. In embodiments this possibility is avoided by making the hard constraints more stringent by specifying a margin 502. This margin acts to separate the improved embedding function from a zero solution of the embedding function. The margin may be defined as:

∀i,j,k vᵢⱼₖ·fᵢⱼₖ≧mᵢⱼₖ. (4)

Here, mᵢⱼₖ are non-negative values, which are strictly positive for some i,j,k, ensuring that the embedding function deviates from zero somewhere. There exist different reasonable choices of margin values that lead to perceptually plausible and similar separating surfaces. Thus, if B is the set of boundary nodes in V, i.e. nodes adjacent to the nodes of the different values in V, mᵢⱼₖ would be:

$${m}_{ijk} = \{ \begin{matrix}0 , & if ( i , j , k ) ∈ B , \\ 1 , & otherwise .\end{matrix} \qquad ( 5 )$$

A margin can also be set equal to the (unsigned) Euclidean distance to the set B:

$$\begin{matrix}{m}_{i , j , k} = dist ( ( i , j , k ) , B ) \\ = {min}_{( α , β , γ ) ∈ B} \sqrt{{( i - α )}^{2} + {( j - β )}^{2} + {( k - γ )}^{2}} .\end{matrix} \qquad ( 6 )$$

The smoothing engine may be arranged to solve the finite difference approximation 501 subject to the margin constraints 502. This is a convex quadratic optimization problem and may be solved using any appropriate sparse second-order optimizer 503. The computationally straightforward nature of the optimizer 503, in which it is possible to readily minimize the gradient means that a solution can quickly be reached, using large step sizes in the finite difference approximation. Typically a sparse second-order optimizer will converge to the function F having a smooth zero-isosurface within a few iterations. First-order, gradient decent, optimizers can also be applied but require more iterations.

The value of the embedding function is most important near the zero isosurface in applications where the zero isosurface corresponds to the surface representation 106 to be found. This means the optimization engine 104 may be arranged to restrict computation to the nodes within a narrow band defined as {(i,j,k)|dist((i,j,k)B)<C}, where C is the constant defining the width of the band which can be set to a small value (e.g. 3) without visually affecting the resulting isosurface. A distance function required to construct the band and to compute the margin values can be efficiently computed by the smoothing engine even for large volumes.

The surface representation 105 can be extracted as the zero isosurface (or other isosurface ) of the optimal embedding function using the iso-surface extraction engine implementing 105 e.g. marching cubes. Alternatively the recovered embedding function can be rendered directly using volume rendering techniques 403.

The methods described in FIG. 4 and FIG. 5 yield surface representations of the input binary volume which are visibly smoother and more natural looking than other methods and which can be efficiently computed and scaled to large volumes.

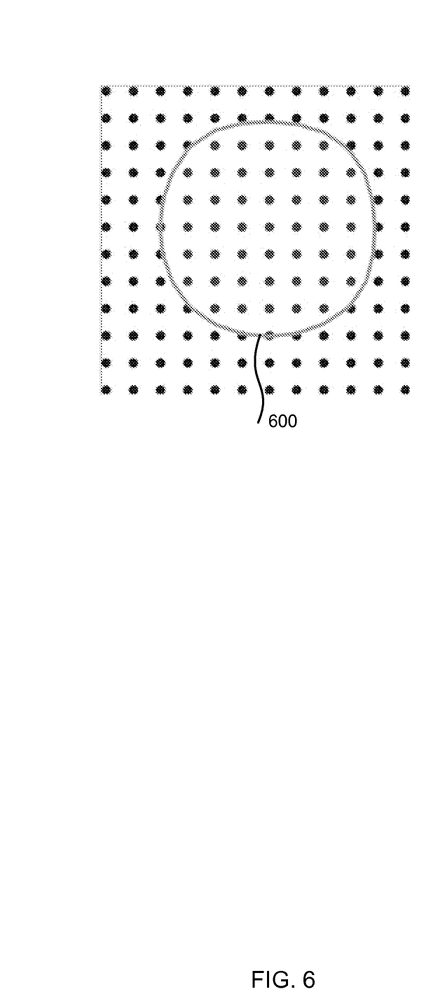

FIG. 6 shows a two dimensional representation of the effect of the method of minimizing a higher-order smoothness criterion imposed on the embedding function. It yields a smooth isosurface 600 with fewer aliasing artifacts which is consistent with the original binary volume (depicting a sphere as in the cases described above with reference to FIG. 3).

In 3D images of scenes where there are thin structures, such as blood vessels in a medical image, the method described in FIG. 4 and FIG. 5 constructs a surface representation that is improved over other methods such as the minimum area surface approach. However, in the case of thin, fine scale (with respect to the binary volume grid spacing) structures shrinking artifacts may be observed. It is recognized herein that this occurs because in these structures the driving of the embedding function towards zero is not prevented as the margin value set using the method described in 502 above is equal to zero for voxels in the thin structures.

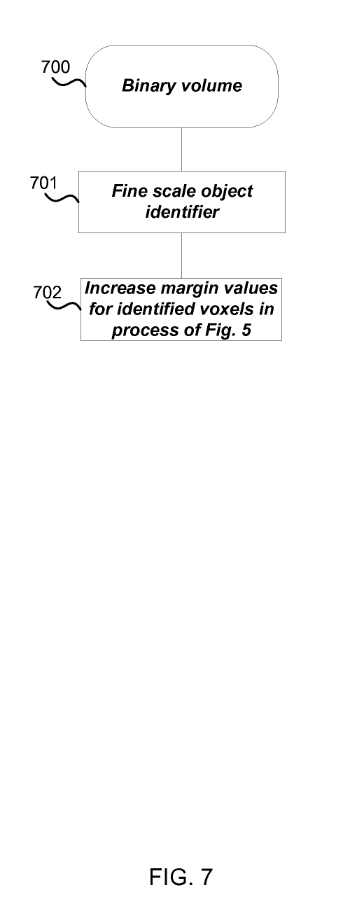

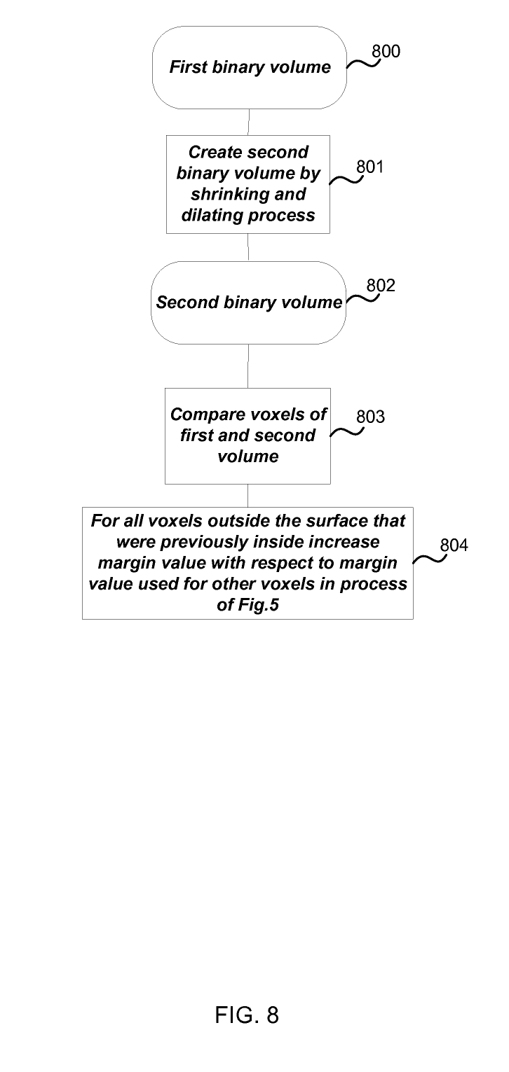

FIG. 7 and FIG. 8 describe a method used to reconstruct fine scale structures at the 3D image processing system. The binary volume 700 is input into a fine scale object identifier 701, which identifies the voxels belonging to fine structures and increases the margin values in these areas 702. The fine scale object identifier 701 carries out any suitable process in order to identify voxels of the binary volume which correspond to objects depicted in the image having a fine scale with respect to the grid spacing of the binary volume. For example, a morphological operation may be used or any other suitable automated process for detecting fine scale structure.

An example of a suitable morphological operation which may be carried out by the smoothing engine is now described with reference to FIG. 8. A first binary volume 800 is input. The input binary volume is shrunk by a specified amount, then dilated by a specified amount 801 to form a second binary volume 802. The voxels of the first binary volume and the second binary volume are the compared 803 in order to identify voxels which are inside the surface in the first binary volume, but outside the surface in the second binary volume. These voxels are identified as fine scale objects that require further processing.

The method of setting a margin as described in 502 above may cause the margin to be set to zero in thin structures. For the voxels identified as outside the surface, that were previously inside, by the comparison 803 the value of the margin is increased 804 to a specified value with respect to the margin value used for other voxels as described in FIG. 5. This improves the performance of the method in the areas of fine scale considerably while allowing the surface to remain virtually unchanged in other parts. The fixing of the value of the margin in these areas does not add complexity making the method equally as computationally efficient to implement at the 3D image processing apparatus.

In the embodiments described above a new 3D image processing system which obtains a surface representation from a binary volume is described. The system is arranged to use minimization of higher order derivatives of a formed embedding function. Such minimization is computationally very efficient and yields smooth surface representations with fewer aliasing artifacts than observed with other methods.

Unlike previous methods, that generally aim at minimizing the area of the separating surface, the approach described herein arranges a processor to minimize a higher-order smoothness criterion imposed on the embedding function. Such minimization can be achieved via solving a convex quadratic optimization problem and yields smooth isosurfaces with fewer aliasing artifacts while being computationally more efficient.

3D image processing as described can be applied to the digital rendering of real-world objects such as statues for e.g. digital heritage rendering or digital museums, as well as medical imaging applications such as MRI scans. The method can also be applied to digital effects rendering for example in films or computer games.

In another embodiment the method can be applied to segmentation results obtained from continuous representations as opposed to binary volumes, for example Geodesic Image Segmentation or level-set frameworks, as the criteria within these methods are not designed to produce surface representations that are smooth at sub-voxel levels and can output a surface representation similar to the minimal area representation 301. In a further embodiment the 3D image processing apparatus can be used for tasks such as multiview reconstruction or shape-from-points within graph-cut and total variation minimization frameworks to provide a fast, ready to use solution for surface extraction.

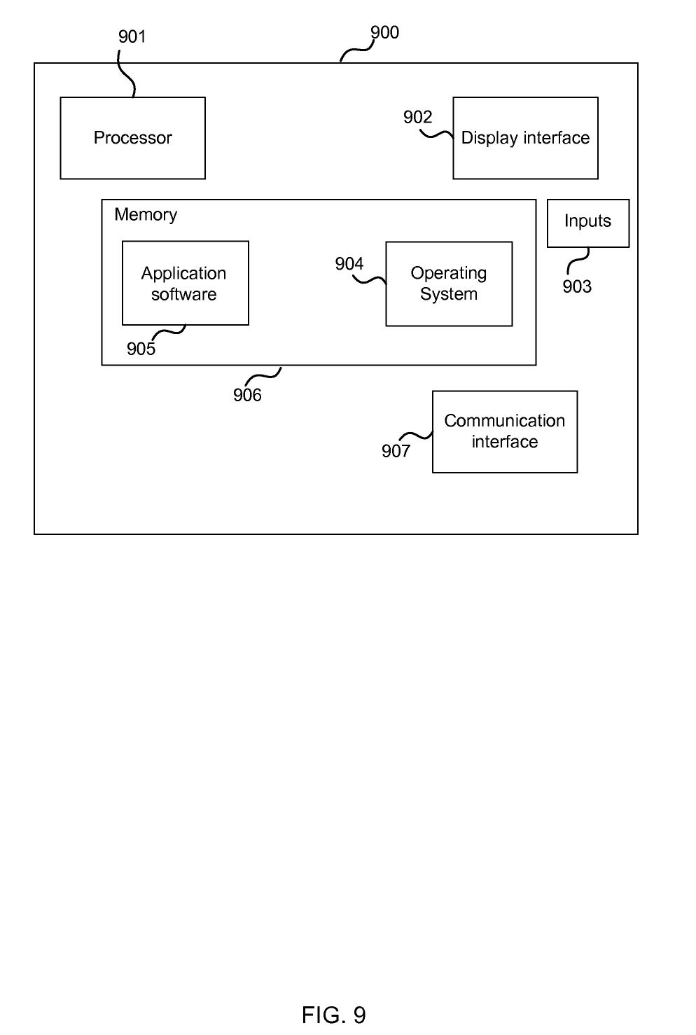

FIG. 9 illustrates various components of an exemplary computing-based device 900 which may be implemented as any form of a computing and/or electronic device, and in which embodiments of a 3D image processing apparatus may be implemented.

The computing-based device 900 comprises one or more inputs 903 which are of any suitable type for receiving media content, Internet Protocol (IP) input, 3D or higher dimensional digital images including moving images such as videos, generated or captured moving images. The device also comprises communication interface 907 to enable the device to connect to a communications network and communicate with other entities on the network

Computing-based device 900 also comprises one or more processors 901 which may be microprocessors, controllers or any other suitable type of processors for computing executable instructions to control the operation of the device in order to carry out 3D image processing. Platform software comprising an operating system 904 or any other suitable platform software may be provided at the computing-based device to enable application software 905 to be executed on the device. The application software 905 can comprise such components as a shape reconstruction engine 102, a smoothing engine 103, an optimizer 104 and an iso-surface extraction engine 105.

The computer executable instructions may be provided using any computer-readable media, such as memory 906. The memory is of any suitable type such as random access memory (RAM), a disk storage device of any type such as a magnetic or optical storage device, a hard disk drive, or a CD, DVD or other disc drive. Flash memory, EPROM or EEPROM may also be used.

An output is also provided such as an audio and/or video output to a display interface 902 integral with or in communication with the computing-based device. The display interface may provide a graphical user interface, or other user interface of any suitable type although this is not essential.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A 3D image processing apparatus comprising:
an input arranged to receive 3D image data comprising a data structure holding a first embedding function representation of the 3D image;
a smoothing engine arranged to form a second embedding function arranged to be substantially consistent with the first embedding function and to regularize at least the second order derivatives of that second embedding function;
an optimization engine arranged to optimize the second embedding function to obtain an improved embedding function;
an output arranged to provide 3D image data comprising the improved embedding function to an iso-surface extraction engine such that in use, surfaces of 3D objects depicted in the 3D image are represented.

2. An apparatus as claimed in claim 1 wherein the input is arranged to receive 3D image data comprising a data structure holding a binary volume of the 3D image.

3. An apparatus as claimed in claim 1 wherein the smoothing engine is arranged to form the second embedding function to comprise hard constraints specified by the first embedding function.

4. An apparatus as claimed in claim 1 wherein the smoothing engine is arranged to also regularize derivatives above second order of the second embedding function.

5. An apparatus as claimed in claim 1 wherein the smoothing engine is also arranged to form the second embedding function by specifying a margin separating the improved embedding function from a zero solution of the second embedding function.

6. An apparatus as claimed in claim 1 wherein the optimization engine is arranged to provide convex optimization.

7. An apparatus as claimed in claim 1 which further comprises a fine scale object identifier arranged to identify voxels of the first embedding function which correspond to objects depicted in the 3D image having a fine scale.

8. An apparatus as claimed in claim 6 wherein the smoothing engine is arranged to form the second embedding function by specifying a margin separating the improved embedding function from a zero solution of the second embedding function and wherein the value of the margin is increased for the identified voxels.

9. An apparatus as claimed in claim 6 wherein the fine scale object identifier is arranged to shrink and dilate the first embedding function which is a binary volume to form a second binary volume and to make a comparison between the binary volume and the second binary volume.

10. An image rendering apparatus comprising:
an input arranged to receive an image which is at least 3D;
a shape reconstruction engine arranged to take the image and provide a binary volume for the image;
a smoothing engine arranged to form an embedding function arranged to be consistent with the binary volume and to regularize at least the second order derivatives of that embedding function;
an optimization engine arranged to optimize the formed embedding function to obtain an improved embedding function;
an iso-surface extraction engine arranged to extract a surface from the improved embedding function which is smooth at sub-voxel levels and provide the surface to a display.

11. An apparatus as claimed in claim 10 wherein the smoothing engine is arranged to also regularize derivatives above second order of the embedding function.

12. An apparatus as claimed in claim 10 wherein the smoothing engine is also arranged to form the embedding function by specifying a margin separating the improved embedding function from a zero solution of the embedding function.

13. An apparatus as claimed in claim 10 wherein the optimization engine is arranged to provide convex optimization.

14. An apparatus as claimed in claim 10 which further comprises a fine scale object identifier arranged to identify voxels of the binary volume which correspond to objects depicted in the 3D image having a fine scale.

15. An apparatus as claimed in claim 14 wherein the smoothing engine is arranged to form the embedding function by specifying a margin separating the improved embedding function from a zero solution of the embedding function and wherein the value of the margin is increased for the identified voxels.

16. An apparatus as claimed in claim 1 4 wherein the fine scale object identifier is arranged to shrink and dilate the binary volume to form a second binary volume and to make a comparison between the binary volume and the second binary volume.

17. A method of processing a 3D image comprising:
receiving a binary volume representation of the 3D image;
using a smoothing engine arranged to form an embedding function arranged to be substantially consistent with the binary volume and to regularize at least the second order derivatives of that embedding function;
using an optimization engine to optimize the formed embedding function to obtain an improved embedding function;
using an iso-surface extraction engine to extract a 3D surface from the improved embedding function and rendering the 3D surface on a display.

18. A method as claimed in claim 1 6 which further comprises forming the binary volume representation from the 3D image.

19. A method as claimed in claim 1 6 which comprises using the smoothing engine to additionally regularize derivatives above second order of the embedding function.

20. A method as claimed in claim 1 6 which comprises using the optimization engine to carry out local convex optimization of the embedding function.
